(19) United States
(12) Patent Application Publication
(10) Pub. No.: US 2025/0124776 A1
(43) Pub. Date: Apr. 17, 2025

(54) SYSTEM, APPARATUS AND DEVICE FOR 3-IN-1 CAMERA

(71) Applicant: HANWHA VISION CO., LTD., Seongnam-si (KR)

(72) Inventors: Jeffrey M. Sweeney, Carlsbad, CA (US); Kevin Darnell, St. Louis, MO (US)

(73) Assignee: HANWHA VISION CO., LTD., Seongnam-si (KR)

(21) Appl. No.: 18/799,998

(22) Filed: Aug. 9, 2024

Related U.S. Application Data
(60) Provisional application No. 63/543,822, filed on Oct. 12, 2023.

(51) Int. Cl. G08B 13/196

(52) U.S. Cl. CPC G08B 13/19691; G08B 13/19602; G08B 13/19628; G08B 13/1966; G08B 13/19697

(57) ABSTRACT

Disclosed are features related to a business intelligence assembly that is combined into a 3-in-1 configuration having security camera functions, visual indicator functions and 2-way voice functions being integrated together, which collectively operate as a Surveillance-Communications-Safety (SCS) hub or act as an active beacon, to cause surveillance operations being combined with communications and safety features that provide business intelligence information.

### RELATED APPLICATIONS

The application claims priority to U.S. Provisional Application Ser. No. 63/543,822, filed Oct. 12, 2023, which is incorporated by reference in its entirety.

### RELATED ART

The present disclosure broadly relates to surveillance operations being combined with communications and safety features to provide business intelligence information.

### BACKGROUND

An example of the related or background art can be found in CN 117407574 entitled: “A kind of warehouse multi-functional status display system.” According to an English language translation of the abstract, “the warehouse multi-function status display system has a sensor monitoring module, a cloud computing platform, a warehouse status display device placed at the front of the warehouse, and a sensor monitoring module. The module is used to collect various status information of the warehouse and transmit it to the cloud computing platform for cloud computing. The platform obtains status processing results through artificial intelligence algorithm calculation processing of various status information in the warehouse and obtains status processing results, that are used to generate abnormal or failure situation alarm information. The warehouse status display device displays warehouse information in a variety of ways, including text, images, charts, sound and light effects, real-time displaying, diverse status display and comprehensive monitoring of various information.”

Another example of the related or background art can be found in KR 10-1498494 entitled: “Multi-functional surveillance camera control system.” According to an English language translation of the abstract, “the present invention relates to a multi-functional surveillance camera system, having a first camera and a second camera attached to the bottom thereof. In addition to video information via the cameras, a small microphone, heat detection sensor, carbon dioxide sensor and illuminance sensors are used to collect information about the surveillance area. When noise, etc. exceeds a pre-determined threshold, an external signal is issued. The video information is transmitted to the server through the Internet network, and the server sends the video information to a pre-designated mobile communication device. Images are transmitted to enable real-time monitoring such that blind spots in surveillance are eliminated and real-time monitoring is possible.”

### BRIEF SUMMARY

However, depending upon where and how such systems, apparatuses and/or methods are implemented, certain improvements and/or enhancements thereto may be needed. Thus, to address such needs, according to at least some embodiments described herein, a 3-in-1 camera system (i.e., a surveillance, communications, safety (SCS) hub, an active beacon, etc.) has been developed to combine surveillance operations with communication capabilities and safety features to provide business intelligence or user awareness information.

### BRIEF DESCRIPTION OF DRAWINGS

The accompanying figures, where like reference numerals refer to identical or functionally similar elements throughout the separate views and which together with the detailed description below are incorporated in and form part of the specification, serve to further illustrate various embodiments and to explain certain principles and effects in accordance with the present disclosure.

FIG. 1 is a schematic diagram of a surveillance camera system, according to one or more embodiments described herein.

FIG. 2 is a schematic structural diagram of a surveillance camera, according to one or more embodiments described herein.

FIG. 3 depicts an exemplary scenario regarding “user awareness” and “business intelligence” according to one or more embodiments described herein.

FIG. 4 shows some basic concepts and/or broad features related to at least a first embodiment that provides for a system (400) comprising a plurality of security cameras (401, 403, 405, 407, 409) that are networked together.

FIG. 5 shows some basic concepts and/or broad features related to at least a second embodiment that provides for an apparatus (500) having a business intelligence assembly (520) combined into a 3-in-1 configuration.

FIG. 6 shows some basic concepts and/or broad features related to at least a third embodiment that provides for a device (600, 700) having an assembly (610) configured as a modified security camera enclosure that is structured to transform a passive security camera installation into an active beacon.

FIG. 7 shows some exemplary details related to FIG. 6, but applicable to one or more other embodiments described herein.

FIG. 8 depicts an exemplary scenario for outdoor applications for one or more embodiments described herein.

Those skilled in the art will appreciate that some elements in the figures are illustrated for simplicity and clarity and have not necessarily been drawn to scale. The dimensions of some elements in the figures may be exaggerated relative to other elements to help to improve understanding of embodiments of the present disclosure.

### DETAILED DESCRIPTION

Before explaining the embodiments in detail, it should be understood that the inventive features described herein are not limited in its application to the details in the construction or arrangement of components or method steps set forth in the following description or illustrated in the drawings. The inventive features are capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, unless specified as such.

The following disclosure is presented to enable a person skilled in the art to make and use embodiments being described. Various modifications to the embodiments will be readily apparent to those skilled in the art, and the generic principles herein can be applied to other embodiments and applications. Thus, the inventive features are not intended to be limited to the embodiments shown but are to be accorded the widest scope consistent with the principles and features disclosed herein. The following detailed description is to be read with reference to the figures that depict selected embodiments and are not intended to limit the scope thereof. Skilled artisans will recognize the examples provided herein have many useful alternatives that still fall within the scope of the embodiments.

The present inventor(s) specifically recognized certain shortcomings in the related art and/or the background art, which led to in-depth research and development activities for achieving the specific technical improvements and/or enhancements with respect to video surveillance implementations to be described hereafter.

At least one or more embodiments to be described hereafter pertains to a so-called “3-in-1 camera” that is specially configured to provide enhanced user awareness and/or better business intelligence based upon surveillance, communications and safety (SCS) features applied to events detected within a surveillance area. In at least one embodiment, an existing traditional “passive” fixed camera installation can be upgraded into an “active” signaling/communication device by adding certain improvements, such as light sources (e.g., LEDs) and also addition 2-way audio capabilities implemented for a modified camera enclosure in accordance with one or more embodiments of this disclosure.

Indoor installation is contemplated for many of the described embodiments, but a more robust outdoor version is also envisioned. From a commercial perspective, the concepts according to the embodiments herein are attractive to customers due to the versatility of the solution(s) provided by the present inventor(s), as well as the ability to pack more functionality into a single installation and/or device.

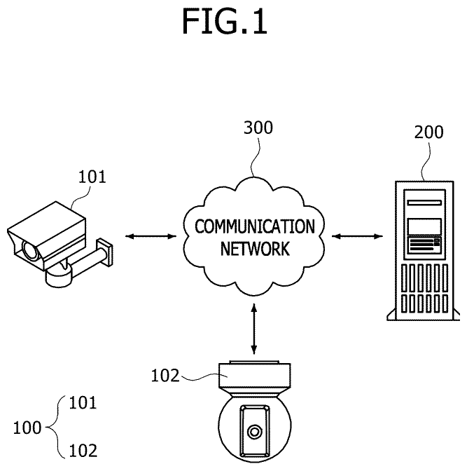

FIG. 1 is a schematic diagram of a surveillance camera system, according to an embodiment.

The surveillance camera system according to an embodiment may transmit and receive image data after encrypting the image data in units. The surveillance camera system may select a method for selecting or determining (hereinafter “selecting”) an encryption target unit, which is at least one unit among a plurality of units constituting an image which is a target of encryption, according to the performance and/or specifications of an image transmission device. In addition, the surveillance camera system may generate a table including identification information about at least one encrypted unit which may include the encryption target unit, encrypt the table and transmit or receive the same.

In the present disclosure, a “unit” may refer to standardized data including at least a portion of an image, such as a moving image or video, for transmission and reception of the image. For example, a unit may refer to a network abstraction layer (NAL) unit generated by compressing an image according to the H.264 compression method. However, this is an example, and the present disclosure is not limited thereto.

In the present disclosure, a “table” may refer to data including identification information about encrypted units among a plurality of units constituting an image. For example, when an image is formed of 10 video coding layer (VCL) NAL units, the table may indicate that selected units (e.g., first, fourth, sixth, ninth, and tenth VCL NAL units) are encrypted. However, this is an example, and the present disclosure is not limited thereto.

In the present disclosure, a “bitstream” may refer to the above-described units that are listed according to the passage of time. For example, a bitstream may be a time-series arrangement of a plurality of units constituting an image for transmission of the image.

As illustrated in FIG. 1, the surveillance camera system according to an embodiment may include a surveillance camera 100 (hereinafter, also referred to as a first surveillance camera 101 and a second surveillance camera 102) as an image transmitting device, an image storage device 200 as an image receiving device, and a communication network 300 for interconnecting them.

The surveillance camera 100 according to an embodiment may be a device that obtains an image of the surrounding environment, partially encrypts the image, and transmits the encrypted image to another device. In the present disclosure, the surveillance camera 100 may be occasionally named and described as an image processing device.

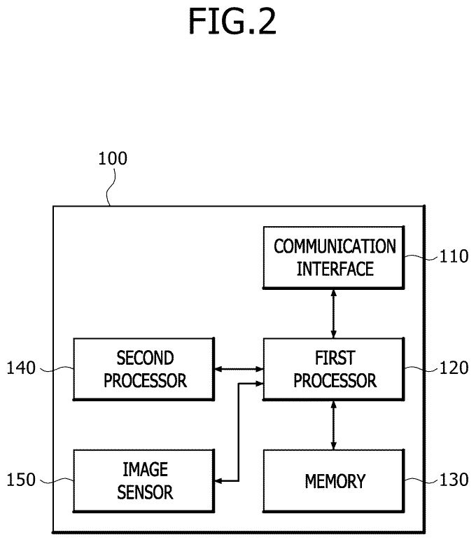

FIG. 2 is a schematic structural diagram of the surveillance camera 100, according to an embodiment.

Referring to FIG. 2, the surveillance camera 100 according to an embodiment may include a communication interface 110, a first processor 120, a memory 130, a second processor 140, and an image sensor 150. The surveillance camera 100 may represent either of the first and surveillance cameras 101 and 102 shown in FIG. 1.

The communication interface 110 may be a device that transmit and receive an image or the like through a wired/wireless connection with another network device such as the image storage device 200. The communication interface may include any one or any combination of a digital modem, a radio frequency (RF) modem, a Wi-Fi chip, and related software and/or firmware.

The first processor 120 may be a device for controlling a series of processes of obtaining an image, segmenting the obtained image into units, and transmitting the units of the image to another network device such as the image storage device 200 through the communication interface 110. Here, the term “processor” may refer to, for example, a data processing device that is embedded in a hardware component and has a physically structured circuit to perform a function expressed as a code or a command included in a program. Examples of the data processing device embedded in a hardware component may encompass processing devices such as a microprocessor, a central processing unit (CPU), a processor core, a multiprocessor, an application-specific integrated circuit (ASIC), a field programmable gate array (FPGA), and the like, but the present disclosure is not limited thereto.

The memory 130 performs a function of temporarily or permanently storing data processed by the surveillance camera 100. The memory may include magnetic storage media or flash storage media, but the scope of the present disclosure is not limited thereto. For example, the memory 130 may temporarily and/or permanently store an obtained image.

The second processor 140 may refer to a device that performs an operation under the control by the above-described first processor 120. In this case, the second processor 140 may be a device having a higher arithmetic capacity than the first processor 120 described above. For example, the second processor 140 may be configured as a graphics processing unit (GPU). However, this is an example, and the present disclosure is not limited thereto. In an embodiment, one second processor 140 may be provided or the second processor 140 may be provided in plurality.

The surveillance camera 100 according to an embodiment may not include the second processor 140. For example, in FIG. 1, a first surveillance camera 101 may be configured to include a second processor, and a second surveillance camera 102 may be configured not to include the second processor.

The image sensor 150 may refer to various types of devices that convert an optical signal into an electrical signal. For example, the image sensor 150 may include a device that obtains ambient light and converts the same into an electrical signal, that is, in the form of an image, such as a charge-coupled device (CCD) or a complementary metal oxide semiconductor (CMOS).

The surveillance camera 100 according to an embodiment may not include the image sensor 150. In this case, despite the word “camera” in its name, the surveillance camera 100 may be a device that performs a function of transmitting an image stored in the memory 130 or an image received from an external device (not shown) to another device.

The image storage device 200 according to an embodiment may be a device for receiving an encrypted image from the surveillance camera 100 and decrypting and decoding the received image. For example, the image storage device 200 may be any one of a Video Management System (VMS), a Central Management System (CMS), a Network Video Recorder (NVR), and a Digital Video Recorder (DVR), or a device included in any one of these.

In the present disclosure, the image storage device 200 is occasionally referred to as an image receiving device. According to an embodiment, the image storage device (the image receiving device) may also include at least one processor, a memory and a communication interface similar to the first and second processors 120 and 140, the memory 130 and the communication interface 110 of the surveillance camera 100 for similar functions.

The communication network 300 according to an embodiment may include, for example, a wired network such as local area networks (LANs), wide area networks (WANs), metropolitan area networks (MANs), integrated service digital networks (ISDNs) or wireless LANs, code-division multiple access (CDMA), Bluetooth, and other wireless networks such as satellite communication, but the present disclosure is not limited thereto.

### Common Theme(s) for Multiple or all Embodiments

It can be said that, when compared with the background art surveillance technologies, “user awareness” with respect to surveillance, communications and/or safety is enhanced or improved according to certain features in two or more embodiments described hereafter. Here, such user awareness can include various types of information that allow a user to make certain business-related decisions. For example, in a large supermarket setting having a plurality of cameras (according to the 3-in-1 cameras in one or more embodiments herein) installed overhead in a matrix-like manner, if at least one camera provides visual and/or audible alerts indicating that too many patrons are lined up at a particular cashier, one or more new cashiers can be opened up to accommodate those patrons waiting in line, in order to reduce crowding incidents that could affect customer safety.

Such user awareness is related to “business intelligence” and/or information related thereto. For example, in the above supermarket scenario, by making additional cash registers available for handling more patrons, the supermarket's bottom line can be increased as more customers can be served in an efficient manner.

Some aspects of such user awareness and/or business intelligence are notified via an interface that provides “alerts” (e.g., visible, audible, perceptible, etc.) about events detected by a security camera with respect to surveillance, communications and/or safety aspects. For example, in the above supermarket scenario, one or more camera installations have specially designed light indicators (e.g., in the form of one or more LED strips) that can turn on or blink or strobe or otherwise operate to provide different types of visual indications via different colors or light effects.

Such specially designed light indicators can be implemented as one or more configurations including, but not limited to, bands, strips, logo designs, lettering, and the like. The dimensions, such as width, length, overall size, specific number of light emitters, etc., of such light indicators would depend upon various factors. For example, a configuration of dual bands, with each band outputting a different color such as red and green, can be implemented in a supermarket setting. The size of one or more bands can be made relatively large, to allow such bands to be observable from a relatively far away. If the installation area for the 3-in-1 cameras is relatively small, the indicator bands could have relatively small widths, as perception thereof would still be possible within the confines of the installation area. It can be said that the specific dimensions and characteristics of the visible, audible and/or perceptible alerts depend upon (and have a particular relationship to) where and how the 3-in-1 cameras, or the security-communication-safety (SCS) hubs, or the active beacons are installed and implemented, as will be described in more detail hereafter.

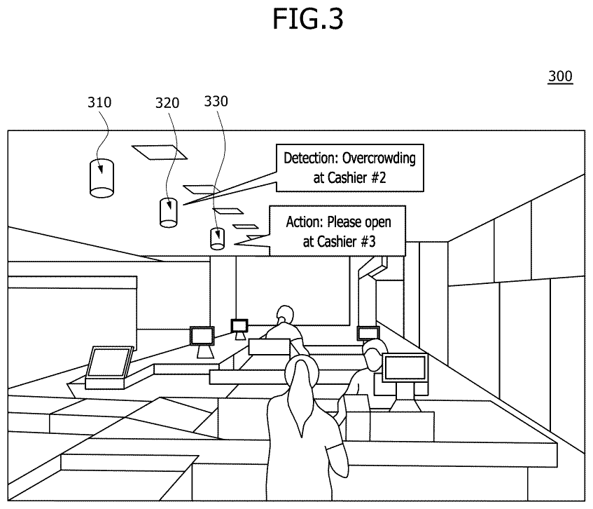

FIG. 3 depicts an exemplary scenario regarding “user awareness” and “business intelligence” mentioned above. In the depicted supermarket setting 300, a network of 3-in-1 cameras (e.g., 310, 320, 330) can automatically detect various types of situations via video capture, image processing, facial recognition, A.I. algorithms and techniques, and the like. For example, camera 329 may detect that there is an overcrowding situation due to many patrons in line at cashier #2. An operator or supermarket staff member, via video overlay processing on a display screen in the control room, can notice this situation. Embodiments described herein can provide on-screen visual notifications, such as the detection status and the action status depicted in FIG. 3. Additionally, visible, audible and/or perceptible alerts can be provided to patrons in the supermarket cashier area. For example, the 3-in-1 camera at cashier #2 can output a flashing red warning light(s) to indicate that there may be an overcrowding situation thereat. Also, the 3-in-1 camera at cashier #3 can output a flashing green light(s) to indicate that a new cashier is being opened up for use. In such manner, supermarket patrons, staff, etc. are provided with “user awareness” and/or “business intelligence” that would not have been possible via conventional camera systems.

Hereafter, specific details related to some exemplary embodiments will be described. Some specific use cases will be described with respect to particular features. However, it can be clearly understood that certain features are applicable to other use cases, and vice versa. Namely, various features described in the embodiments herein (including visual signaling, audible signaling, 2-way voice functions, A.I.-driven functions, automated deterrents, manual deterrents, etc.) are applicable to situations related to indoor security, outdoor security, business intelligence, retail establishments, education environments, healthcare facilities, finance and banking sectors, hotel and lodging locations, safety awareness, compliance awareness, and the like.

Hereafter, some use cases and scenarios will be explained according to several embodiments.

### First Embodiment

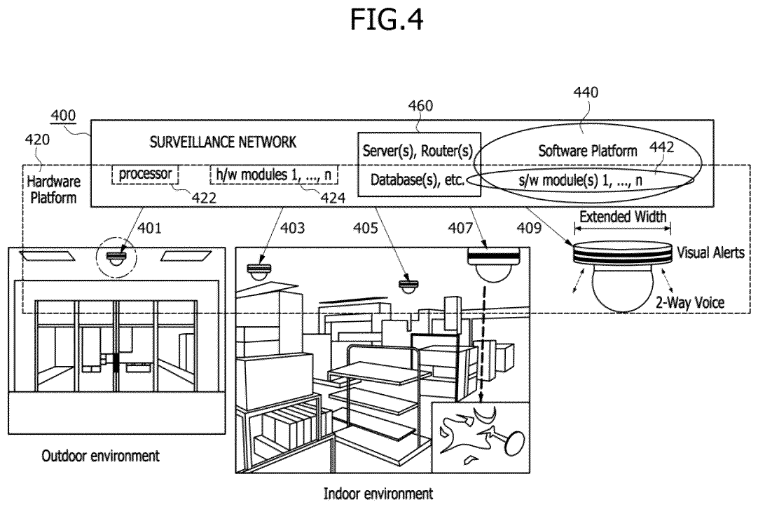

With reference to FIG. 4, at least some basic concepts and/or broad features related to the first embodiment provides for a system (400) comprising a plurality of security cameras (401, 403, 405, 407, 409) that are networked together, each camera having related thereto: a hardware platform (420) comprising a visual alerts module (424) and an audible alerts module (424) that operate in accordance with events at or near at least one of the networked security cameras; and a software platform (440) comprising software modules (442) that support the visual alerts module and the audible alerts module of the hardware platform, wherein a combination of the cameras, the hardware platform and the software platform cooperate to provide improved user awareness with respect to surveillance, communications and safety when compared to a system that lacks the combination.

Here, the security cameras may be those that are currently used in the surveillance industry. For example, Hanwha's products for pan tilt zoom (PTZ) cameras can be employed, but the embodiments described herein are not limited thereto. The features of such cameras (as explained in commonly owned U.S. patents, such as U.S. Pat. No. 10,043,079B2, U.S. Pat. No. 10,783,648B2 and U.S. Pat. No. 10,341,616B2) will not be explained in detail but are still part of this disclosure via incorporation by reference of these patents in their entirety. The network connectivity can be achieved in a variety of ways, including but not limited to, LAN connections, wireless communications, ad hoc networking, edge computing, telecommunications and the like.

The hardware platform contains one or more processor (422) and/or controllers that provide overall control for the system. Additionally, image and video processing that employs metadata, image data, histograms, artificial intelligence (AI), machine learning (ML), and the like are supported by the hardware platform.

The visual alerts module includes light sources and/or other elements that provide visible cues or outputs. The particular types, sizes, layouts, configurations, etc. of such visual alerts can be varied according to the specific implementation needs.

The audible alerts module includes input and output devices, such as microphones and speakers, that support audible interfacing related to the area under surveillance. Sounds, alerts, and the like can be provided to person(s) in the surveillance area and voice commands can be picked up and processed as well.

The software platform contains various types of modules (442), which contain instructions and/or software codes that are executable by the processor and/or controller in the hardware platform. The processing needed to support various types of video codecs and audio codecs are also performed in the software platform, upon cooperation with elements in the hardware platform.

The hardware and software platforms can contain elements or features that are interchangeable or substituted. In some embodiments, certain features could be implemented as firmware and/or other types of hardware-software combination.

Meanwhile, providing improved user awareness with respect to surveillance, communications and safety when compared to a system that lacks the combination is achieved by one or more embodiments of the inventive system, because the hardware and software platforms are configured such that the visual and/or audible alerts are provided to users in a more meaningful manner. For example, if the system is implemented along the ceiling region of a large supermarket, the visual alerts via a particular camera (407) provides light outputs that indicate a potentially dangerous situation due to a broken glass item on the floor. Upon such situational recognition, the supermarket management can take measures to clean up the hazard to ensure safety.

As another example, such visual alerts can be provided at certain cashier locations with too many customers in line, which may be a safety hazard due to overcrowding. Upon such situational recognition, the supermarket management can quickly open up new cashiers to cater to the waiting customers. Such meaningful alerting simply cannot be provided by a conventional system that lacks such combination.

In such system, each camera operates in an active manner according to event-driven or schedule-driven signaling, rather than based upon simple motion detection.

Here, event-driven signaling refers to processing or signal generation based upon one or more events or occurrences that take place at or near one or more security cameras. Such events may be detected in an automatic manner via sensors or detectors. Alternatively, such detection can be done manually by an operator or manager and a viewing station that allows monitoring of all or multiple security cameras for a particular surveillance area.

Schedule-driven signaling refers to processing or signal generation based upon a schedule according to set time periods. For example, if the system is implemented in a commercial environment such as a store, the visual and audible alerts can be set for triggering during the hours when the store is closed. Such scheduling can be set for automatic operation or for manual operation.

In such system, the visual alerts module provides the improved user awareness via light emitting diodes (LEDs) configured in bands or strips that indicate different information or visual cues according to different colors or light operation effects.

Here, such visual cues are adapted to be clearly visible to operators or user who are located at a certain distance away from a particular camera. For example, for a concert venue or at a similar location where crowds gather in a bottleneck manner, a plurality of cameras can be placed along multiple entrances or exits. As people gather at a particular entrance or exit, if overcrowding is detected or is anticipated, the LED bands that can be seen from afar may show red colors or blinking effect to indicate that too many people at that area, which would allow some patrons to go to a different entrance or exit that is much less crowded.

In such system, the different information or visual cues are not from operation status lights, infrared LEDs for image capture, nor floodlights for the security camera.

Here, it should be noted that conventional types of indicators should be distinguished from the features intended and provided by the embodiments described herein. Namely, some conventional cameras may have indicator lights that show an operation status of that camera. In contrast, the visual cues from the embodiments herein are distinct from or not related to such camera operation status lights.

In such system, the cameras, the hardware platform and the software platform employ at least one among artificial intelligence (AI) video processing and video analytics that support edge computing techniques to achieve the improved user awareness.

Here, in order to provide improved user awareness with respect to surveillance, communications and safety, features related to artificial intelligence (A.I.) can be additionally employed. For example, certain situations that trigger the visual and audible alerts according to some embodiments herein can be anticipated ahead of time. If the image or video feeds from the security cameras show that an overcrowding situation could be forthcoming, the system could provide alerts in a more timely manner as safety hazard issues could be accurately predicted by using A.I. or machine learning algorithms based upon the video or image data that is currently being captured. Of course, such A.I., machine learning, or other similar techniques may be employed for other situation that need anticipation or prediction, which fall under the scope of the embodiments described herein.

In such system, the audible alerts module does not include its own speakers, with an existing public announcement (PA) system being employed instead.

Here, if the system is to be implemented at a surveillance area that already has certain equipment installed or used thereat, such existing equipment could be leveraged without having to have such components be part of the system according to the inventive embodiments described herein. For example, a public announcement (PA) system may be one such pre-installed equipment. In such case, the hardware platform according to the embodiments need not have any speakers included therein. Such can save costs and installation issues.

In such system, the audible alerts module supports 2-way voice functions that allow certain user interactions related to the events at least one security camera.

Here, the system according to the present disclosure can have user interactive functions that allow voice or sounds to be recognized. For example, in order to provide immediate verbal assistance or guidance to a user in a surveillance area, some embodiments herein are equipped with 2-way voice functions. As such, a system monitoring staff member may observe a situation via a particular security camera and provide verbal instructions to that user at that location.

In such system, the bands or strips of LEDs of a particular camera are configured to allow perception from underneath that particular camera.

In some implementations, user awareness can be provided to those users located right under or just beneath a particular security camera. For example, users that are far away from such visual alerts, such as the LED band lights, may be able to recognize such, but someone underneath that camera location may have difficulties in seeing such light alerts. As such, the system may be further equipped to solve this situation. For example, a light source directed to allow recognition from beneath the camera can be employed to ensure that such users perceive such indications if needed.

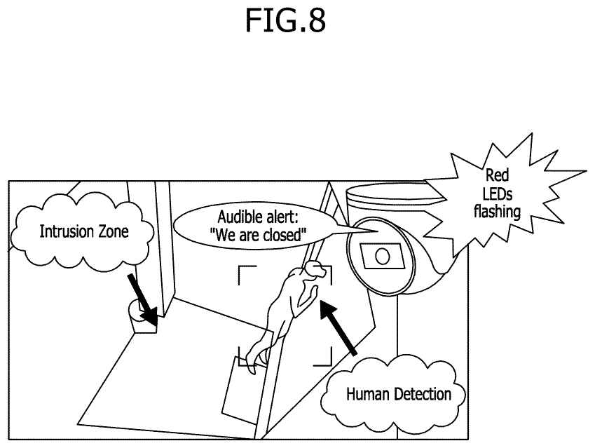

FIG. 8 depicts an exemplary scenario for outdoor applications for one or more embodiments described herein.

The simplified scenario shows a nighttime shot of a premises or store exterior when closed, with a visible colored light (or ring illumination) around or at the camera, and showing a potential burglar looking like they are about to break in. A particular selling point of the inventive embodiments is by letting the bad guy know they are under surveillance and that providing visual/or audible “alerts” could prevent any crime before it happens. The costs associated with a break-in, such as repairing broken windows or doors often costing more than stolen merchandise, could be minimized by the embodiments related to the 3-in-1 camera scheme is a genuine asset for loss prevention. Such nighttime image capture can be achieved in a variety of ways, including but not limited to infrared (IR) imaging, night vision technologies, color night vision, thermal imaging, and the like.

### Second Embodiment

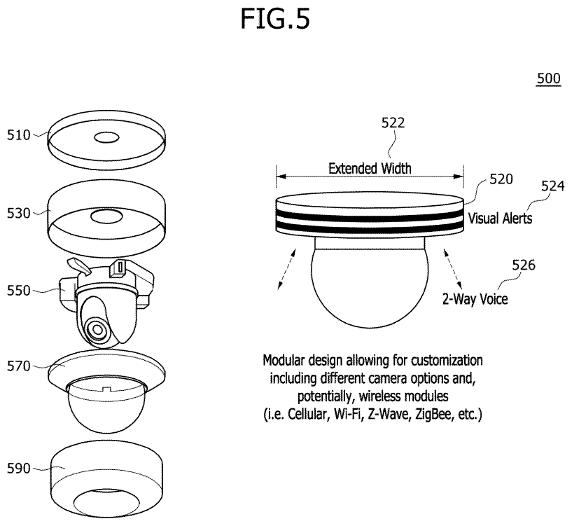

With reference to FIG. 5, at least some basic concepts and/or broad features related to the second embodiment provides for an apparatus (500) comprising: a housing (530); and a business intelligence assembly (520) at the housing and being combined into a 3-in-1 configuration having security camera functions (550), visual indicator functions (524) and 2-way voice functions (526) being integrated together, which collectively operate as a Surveillance-Communications-Safety (SCS) hub to cause surveillance operations being combined with communications and safety features that provide business intelligence information, wherein the apparatus is configured to support a plurality of functionalities comprising light emitting diode (LED) band indicators, an audio interfacing and wireless connectivity, and the apparatus is structured to have a modular design that selectively accommodates the plurality of functionalities.

Here, the term “Surveillance-Communications-Safety (SCS) hub” is merely exemplary, as other similar terms can be used interchangeably. Such naming scheme is used to describe that at least some embodiments herein provide enhanced capabilities when compared to a conventional security camera.

Also, “business intelligence” can refer to a combination of business analytics, data mining, data visualization, data tools, infrastructure and best practices. By implementing at least some embodiments described herein, certain visual and/or audible alerts are provided to users in a more meaningful manner to help companies or organizations make more data-driven decisions. For example, if such SCS hub or apparatus is implemented in a warehouse environment, the 3-in-1 configuration and functionalities thereof can be used to support four key concepts of business intelligence, namely, data collection, data analysis, information visualization and decision making, in order to obtain and provide insights and trends for improving business management, which would not be possible by using conventional security camera installations.

In such apparatus, the SCS hub provides the visual indicator functions via the LED band indicators in terms of visual alerts that are not operation status lights, infrared LEDs for image capture, nor floodlights for the security camera.

Here, it should be noted that conventional types of indicators should be distinguished from the features intended and provided by the embodiments described herein. Namely, some conventional cameras may have indicator lights that show an operation status of that camera. In contrast, the visual cues from the embodiments herein are distinct from or not related to such camera operation status lights.

In such apparatus, the SCS hub operations are supported by a processor in the business intelligence assembly to cause the surveillance operations to be combined with the communications and safety features by processing security camera images or video streams in connection with safety requirements and being communicated via the LED band indicators, the audio interfacing and the wireless connectivity to achieve real-time feedback to users.

Here, if the SCS hub or apparatus in implemented in a hotel setting, the LED band indicators, the audio interfacing and the wireless connectivity provide useful information about guests checking in and out, provide visual deterrents against unlawful activities, provide security personnel with better communications, detect potential issues with respect to guests or staff entering and existing certain areas, improve guest experiences by letting them know when their room has been cleaned, check for compliance related to Occupational Safety and Health Administration (OSHA) laws or other compliance regulations, and the like. Accordingly, such analytics and intelligence platform can provide enhanced security, improved safety, better customer experience and operational efficiencies.

In such apparatus, the SCS hub operations are enhanced by having multiple business intelligence assemblies, which are strategically located according to a specific layout that provides appropriate coverage in a particular environment, whereby structural configurations of the LED band indicators, the audio interfacing and the wireless connectivity are adapted for the particular environment such that the visual alerts and the business intelligence information are provided in an intuitive manner.

Here, a plurality of SCS hubs or apparatuses can be provided in a networked manner by being positioned according to a specific layout or grid arrangement. For example, in a large storage facility or logistics center, a specific type of optimization related to how spaced part the SCS hubs should be placed can be considered and implemented. For example, the square footage of the overall facility, the specific times as to when the facility is heavily in use or occupied, and the like are taken into account. There would also be a trade-off as to cost versus practicality with respect to how the SCS hubs should be installed, operated and maintained in such a large area. Thus, among numerous SCS hubs, only some can be activated at particular times depending upon a status of how crowded the storage facility is. If only a few pallets having boxes stacked thereon are present at a particular time, only those SCS hubs that is near such pallets need to be activated. As modular implementation is also supported by the SCS hubs, additional functions can be added to at least some of the SCS hubs as business improves or increases, which can minimize the need for installing new hubs or apparatuses, thus saving costs to the facility operating company.

In such apparatus, the business intelligence assembly further employs at least one among video-processing-related artificial intelligence (A.I.) and video analytics that analyze data related to the LED band indicators, the audio interfacing and the wireless connectivity to provide the business intelligence information.

For implementation in the finance or banking industry, matters related to safety, compliance and customer service may be at issue. The SCS hub can have a camera with modified “line crossing/exclusion zone” capabilities installed directly over an automated teller machine (ATM) facing outwards. Such configuration creates a virtual privacy and safety zone for a customer using the ATM. When a customer(s) enters the area immediately in front of the ATM, the system would recognize their presence and proceed to establish the virtual safety zone. The presence of any other person(s) who cross into the designated zone before the customer(s) exits would result in visual and/or audible warnings. Also, the SCS hub can have a camera equipped with the ability to count people in line, which can be leveraged in conjunction with visual signaling to indicate the need for additional front-line personnel to assist additional customers if a threshold number of waiting customers is met or exceeded. Such signaling may be performed automatically based on sensing or detecting mechanisms or can be manually set by a bank teller or employee at their workstation.

In such apparatus, the business intelligence information pertains to schedule-based detections, event-based detections, premises entry or exit detection, loitering detection, situational awareness and compliance detection with respect to a retail environment.

Here, in a healthcare environment, the use of specialized A.I. techniques and visual signaling can indicate obstructions and loitering in hallways or other areas of interest, such that safety and compliance can be dealt with. To support patient or resident comfort, the use of a microphone (or other sound pick-up device) to detect sound levels in hallways near a patient room in a hospital or a medical residential facility, and visual signaling can be activated if detected noise level thresholds are met or exceeded. For patient wandering issues, the use of A.I. techniques to count or anticipate entries and exits for a patient's room can be implemented. If a patient leaves their room during an unauthorized time, visual and/or audible signaling can be activated to prevent this from happening.

In such apparatus, the modular design permits customization with respect to the security camera functions, the visual indicator functions and the 2-way voice functions that employ the LED band indicators, the audio interfacing and the wireless connectivity.

Here, with respect to education use cases, safety and compliance for student and teachers can be achieved. For example, visual signaling can be linked to a time clock to provide students and teachers with visual cues (e.g., green, yellow, red) regarding the approximate remaining time available while changing classes, during lunch break, etc. The use of facial recognition, A.I. algorithms, etc. to detect students without a hall pass during class hours, unauthorized persons in the hallways, etc. and appropriate visual and/or audible signaling via 2-way voice can lead to compliance in these situations. In addition, visual and/or audible signaling can be used to provide awareness to potentially dangerous buildup of students or people in hallways or stairwells during times when a crowds gather in a short amount of time in limited spaces. Such visual and/or audible signaling can also be employed during safety evacuation drills and events with the cameras being leveraged to provide evidence or records of the actual event for review and success planning.

Here, for implementation in a retail environment, safety and compliance issues, such as avoiding OHSA fines, can be handled. For example, the use of specialized A.I. technology can detect blocked access to fire exits, fire extinguishers, fire alarms or other such areas legally requiring access per local, state or federal mandates. Visual and/or audible signaling can be used to drive employee compliance. This solution may employ a configurable timer to allow sufficient time for the loading and unloading of delivery trucks, which could result in a temporary blockage of areas which normally require unobstructed passage pr access.

Also, parking lot safety can be another use case scenario. Here, cameras are used to detect the presence and/or loitering during non-business hours, while visual and/or audible signaling can be used to tell people in the area that the business is closed of that they are required to leave to property. The ability to configure this solution to allow for an escalation logic (i.e., automated to manual intervention) to include a “talk down” intervention” with a live operator is also possible.

In such apparatus, the modular design includes a mount unit and a cover that are structured for outdoor installation, the cover having a curved or dome-like outer surface that deflects things from attaching onto or remaining in contact thereof.

For an outdoor premises of a retail establishment, vandals may attempt to disable the apparatus or SCS hub in a physical manner by throwing things thereto. To minimize such from happening, the cover or top portions of the apparatus or SCS hub can be configured to prevent such vandalism.

### Third Embodiment

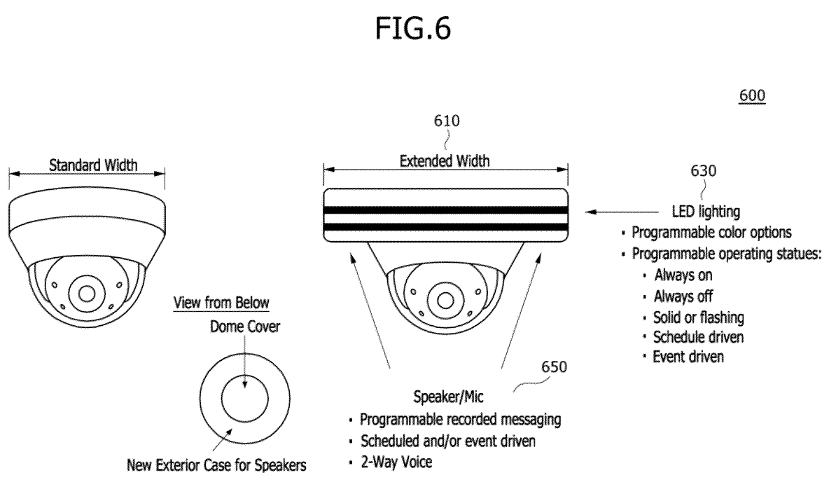

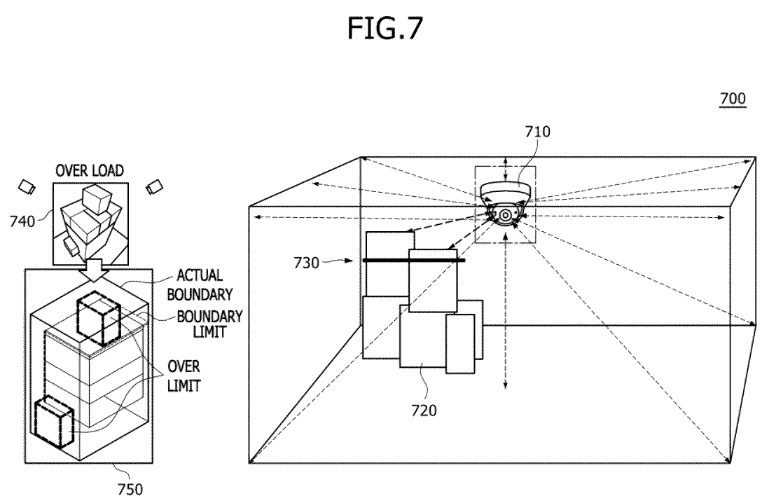

With reference to FIGS. 6 and 7, at least some basic concepts and/or broad features related to the third embodiment provides for a device (600, 700) comprising: an assembly (610) configured as a modified security camera enclosure that is structured to transform a passive security camera installation into an active beacon that employs a visual alert interface (630) providing visual alerts about events detected by a security camera with respect to surveillance, communications and safety, and assembly also employs at least two among: a 2-way voice interface (650) that supports audible inputs and outputs related to the visual alerts, a boundary or height sensor (710) that performs boundary or height detection for objects (720, 740, 750) at a particular physical location near the security camera, and a wireless connectivity that provides wireless communication related to the events detected by the security camera.

Here, the term “active beacon” is merely exemplary, as other similar terms can be used interchangeably. Such naming scheme is used to describe that the embodiments herein provide enhanced capabilities when compared to a conventional security camera.

The active beacon according to this embodiment is configured or structured to be an add-on type solution to an existing security camera. Such assembly can be configured for many different situations to support legacy camera systems and technologies. Here, in order to ensure backward compatibility, at least some of the features for the active beacon may be configured to handle standardized functionalities. For example, the active beacon can have hardware and connectors that can easily interface with an existing security camera such that a “plug-and-play” type of operation can be enabled. Also, on a software level, the active beacon can support functions that comply with certain types of industry regulations (e.g., various ISO standards, etc.) and/or technical standards (e.g., Wi-Fi/LTE/5G for network connectivity, H.264/265/266 for video codec and processing, etc.) to properly support numerous functionalities.

In such device, the visual alerts are not operation status lights, infrared LEDs for image capture, nor floodlights for the security camera.

Here, it should be noted that conventional types of indicators should be distinguished from the features intended and provided by the embodiments described herein. Namely, some conventional cameras may have indicator lights that show an operation status of that camera. In contrast, the visual cues from the embodiments herein are distinct from or not related to such camera operation status lights.

In such device, the boundary or height sensor employs time-of-flight (ToF) technology that causes an alarm to be activated to provide real-time user feedback with respect to safety or compliance under Occupational Safety and Health Administration (OSHA) requirements.

A time-of-flight camera (ToF camera) measures distance according to the time it takes for the emitted light to be reflected back. In more detail, the device can employ a ToF camera (also known as time-of-flight sensor (ToF sensor)), which is a range imaging camera system for measuring distances between the camera and the target for each point of the image based on time-of-flight (i.e., the round trip time of an artificial light signal) as provided by a laser or an LED. Laser-based ToF cameras/sensors are part of a broader class of scanner-less LIDAR (Light Detection and Ranging), in which the entire scene is captured with each laser pulse, as opposed to point-by-point capturing with a laser beam, such as in scanning LIDAR systems. So-called Direct-ToF used for directly measuring time, so-called Indirect-ToF used for measuring time via phase characteristics related to emitted signals, received signals and a correlation therebetween, and the like can be employed.

In addition, various other types of technologies can be used instead of or in addition to the time-of-flight (ToF) sensors mentioned above. For example, thermal sensing or detection can be implemented into one or more embodiments described herein. Such non-vision-based sensors or equivalents provide for additional detection capabilities that would be useful in a wide variety of applicable scenarios.

Furthermore, various types of auxiliary inputs and/or outputs can be further integrated into the one or more embodiments described herein. For example, a motion detector can be installed in an area without camera coverage as an auxiliary input device. If motion is detected by the motion detector, the camera is controlled to orientate towards the general location of the hidden movement in anticipation of the person/animal moving into the coverage area. The light band (or other visual indicator LEDs, etc.) changes from “green” to “yellow” to visually signal such non-viewable activity, provide user awareness, enhance business intelligence, and the like.

The 3-in-1 camera (of one or more embodiments described herein) can be integrated with a so-called Access Control system, which can be implemented in such surveillance situations. If “tailgating” occurs, whereby, only 1 person scans their badge (or other personal identifying means) but more than 1 person enters, the LEDs (or other visual indicators) on the 3-in-1 camera would change from “green” to “red” and 2-way voice communication is initiated between the group entering the building and security personnel. In such manner, improved access control can be achieved with integration with one or more embodiments described herein.

In such device, the modified security camera enclosure is structured to be in compliance with regulatory or technical standards that define how the visual alert interface, and at least two among the 2-way voice interface, the boundary or height sensor and the wireless connectivity are legacy-oriented or backwards compatible with the passive security camera installation.

Here, referring to FIG. 7, a camera having one or more boundary or height sensors implemented thereto (710) can detect objects, such as boxes, in a particular area. Depending upon implementation, a single camera or a pair of cameras can be used. For boundary or height detection, an actual camera image of the boxes (740) may be used and/or a processed image of the boxes (750), which can show to the viewer an actual boundary, a boundary limit and an over-limit situation, may be used. The height detection can also be performed via threshold parameters and/or indicators (730) related to the objects (or boxes) in the storage area. A threshold parameter can be a maximum allowed stacking height value that the cameras and/or sensors refer to. An indicator can be painted height markings along the walls of the storage area that the cameras and/or sensors can detect. It can be understood that other types of parameters and/or indicators (730) can be employed according to the embodiments described herein.

### Additional Embodiments

The present inventor(s) clearly contemplated the possibility of combining certain features in different embodiments into a single or the same embodiment. For example, one or more features in the hardware platform and/or the software platform can be also implemented into the second embodiment and/or the third embodiment. As another example, the LED band indicators explained in the second embodiment could be additionally implemented into the first embodiment and/or the third embodiment. As a further example, the boundary/height sensor of the third embodiment could be further implemented into the first embodiment and/or the second embodiment.

Such feature combinations would result in a fourth embodiment and/or subsequent additional embodiments, which contain features that all still fall within the scope of the various concepts and characteristics of the inventive features described herein.

At least some basic concepts and/or broad features related to the inventive embodiments described herein can be stated as follows:

Here, it should be noted that at least some features in one or more the embodiments described herein were not simply developed due to mere reasonable expectation of success based on routine experimentation or routine testing. However, it should be noted that patentability shall not be negated by the manner in which the invention was made and thus, so-called “routine experimentation” in and of itself does not necessarily preclude patentability.

In addition, the following technologies can be applied to at least some features described in the embodiments herein.

WebRTC (Web Real-Time Communication) is an open-source technology that provides web browsers and mobile applications with real-time communication (RTC) features via application programming interfaces (APIs). Additionally, audio and video communication and streaming are provided to work within web pages by allowing direct peer-to-peer communication, eliminating the need to install plugins or download native applications.

It can be said that the purpose of WebRTC is to enable rich, high-quality RTC applications to be developed for the browser, mobile platforms, and IoT devices, and allow them all to communicate via a common set of protocols.

WebRTC technical specifications are published by the World Wide Web Consortium (W3C) and the Internet Engineering Task Force (IETF). W3C is developing ORTC (Object Real-Time Communications) for WebRTC.

Such WebRTC techniques are applicable to at least one among the video surveillance subsystem (platform), the positioning subsystem (platform) and the management subsystem (platform) described herein.

Some major components of WebRTC include certain JavaScript APIs which may be applicable to the embodiments herein:

For example, getUserMedia acquires the audio and video media data.

Also, RTCPeerConnection enables audio and video communication between peers, by performing signal processing, codec handling, peer-to-peer communication, security, and bandwidth management.

Additionally, RTCDataChannel allows bi-directional communication of data between peers. Such data is transported using Stream Control Transmission Protocol (SCTP) over Datagram Transmission Layer Security (DTLS). It uses the same API as WebSockets and has very low latency.

The WebRTC API also includes a statistics function that allows a web application to retrieve a set of statistics about WebRTC sessions.

The WebRTC API includes no provisions for signaling, that is discovering peers to connect to and determine how to establish connections among them. Applications use Interactive Connectivity Establishment for connections and are responsible for managing sessions, possibly relying on any of Session Initiation Protocol, Extensible Messaging and Presence Protocol (XMPP), Message Queuing Telemetry Transport, Matrix, or another protocol.

With respect to some exemplary technical standard related documents, RFC 7478 requires implementations to provide PCMA/PCMU (RFC 3551), Telephone Event as DTMF (RFC 4733), and Opus (RFC 6716) audio codecs as minimum capabilities. The PeerConnection, data channel and media capture browser APIs can be found in the W3C specification.

In addition, at least some features in one or more embodiments described herein are related to one or more technical standards, such as ISO/IEC 24730 and/or other standards related or relevant thereto, which continue to evolve with ongoing updates thereof. As such, at least some features described herein would be applicable to certain updates of one or more ISO/IEC 24730 based standards.

It will be appreciated by those skilled in the art that while the inventive features have been described above in connection with particular embodiments and examples, such inventive features are not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and aspects of the inventive concepts are set forth in the following claims.

What is claimed is:

1. A system comprising:
a plurality of security cameras that are networked together, each camera having related thereto:
a hardware platform comprising a visual alerts module and an audible alerts module that operate in accordance with events at or near at least one of the networked security cameras; and
a software platform comprising software modules that support the visual alerts module and the audible alerts module of the hardware platform,
wherein a combination of the cameras, the hardware platform and the software platform cooperate to provide improved user awareness with respect to surveillance, communications and safety when compared to a system that lacks the combination.

2. The system of claim 1, wherein each camera operates in an active manner according to event-driven or schedule-driven signaling, rather than based upon simple motion detection.

3. The system of claim 2, wherein the visual alerts module provides the improved user awareness via light emitting diodes (LEDs) configured in bands or strips that indicate different information or visual cues according to different color or light operation effects.

4. The system of claim 3, wherein the different information or visual cues are not from operation status lights, infrared LEDs for image capture, nor floodlights for the security camera.

5. The system of claim 4, wherein the cameras, the hardware platform and the software platform employ at least one among artificial intelligence (AI) video processing and video analytics that support edge computing techniques to achieve the improved user awareness.

6. The system of claim 5, wherein the audible alerts module does not include its own speakers, with an existing public announcement (PA) system being employed instead.

7. The system of claim 5, wherein the audible alerts module supports 2-way voice functions that allow certain user interactions related to the events at least one security camera.

8. The system of claim 5, wherein the bands or strips of LEDs of a particular camera are configured to allow perception from underneath that particular camera.

9. An apparatus comprising:
a housing; and
a business intelligence assembly at the housing and being combined into a 3-in-1 configuration having security camera functions, visual indicator functions and 2-way voice functions being integrated together, which collectively operate as a Surveillance-Communications-Safety (SCS) hub to cause surveillance operations being combined with communications and safety features that provide business intelligence information,
wherein the apparatus is configured to support a plurality of functionalities comprising light emitting diode (LED) band indicators, an audio interfacing and wireless connectivity, and the apparatus is structured to have a modular design that selectively accommodates the plurality of functionalities.

10. The apparatus of claim 9, wherein the SCS hub provides the visual indicator functions via the LED band indicators in terms of visual alerts that are not operation status lights, infrared LEDs for image capture, nor floodlights for the security camera.

11. The apparatus of claim 10, wherein the SCS hub operations are supported by a processor in the business intelligence assembly to cause the surveillance operations to be combined with the communications and safety features by processing security camera images or video streams in connection with safety requirements and being communicated via the LED band indicators, the audio interfacing and the wireless connectivity to achieve real-time feedback to users.

12. The apparatus of claim 11, wherein the SCS hub operations are enhanced by having multiple business intelligence assemblies, which are strategically located according to a specific layout that provides appropriate coverage in a particular environment, whereby structural configurations of the LED band indicators, the audio interfacing and the wireless connectivity are adapted for the particular environment such that the visual alerts and the business intelligence information are provided in an intuitive manner.

13. The apparatus of claim 9, wherein the business intelligence assembly further employs at least one among video-processing-related artificial intelligence (AI) and video analytics that analyze data related to the LED band indicators, the audio interfacing and the wireless connectivity to provide the business intelligence information.

14. The apparatus of claim 13, wherein the business intelligence information pertains to schedule-based detections, event-based detections, premises entry or exit detection, loitering detection, situational awareness and compliance detection with respect to a retail environment.

15. The apparatus of claim 9, wherein the modular design permits customization with respect to the security camera functions, the visual indicator functions and the 2-way voice functions that employ the LED band indicators, the audio interfacing and the wireless connectivity.

16. The apparatus of claim 15, wherein the modular design includes a mount unit and a cover that are structured for outdoor installation, the cover having a curved or dome-like outer surface that deflects things from attaching onto or remaining in contact thereof.

17. A device comprising:
an assembly configured as a modified security camera enclosure that is structured to transform a passive security camera installation into an active beacon that employs a visual alert interface providing visual alerts about events detected by a security camera with respect to surveillance, communications and safety, and assembly also employs at least two among:
a 2-way voice interface that supports audible inputs and outputs related to the visual alerts,
a boundary or height sensor that performs boundary or height detection for objects at a particular physical location near the security camera, and
a wireless connectivity that provides wireless communication related to the events detected by the security camera.

18. The device of claim 17, wherein the visual alerts are not operation status lights, infrared LEDs for image capture, nor floodlights for the security camera.

19. The device of claim 18, wherein the boundary or height sensor employs time-of-flight (ToF) technology that causes an alarm to be activated to provide real-time user feedback with respect to safety or compliance under Occupational Safety and Health Administration (OSHA) requirements.

20. The device of claim 19, wherein the modified security camera enclosure is structured to be in compliance with regulatory or technical standards that define how the visual alert interface, and at least two among the 2-way voice interface, the boundary or height sensor and the wireless connectivity are legacy-oriented or backwards compatible with the passive security camera installation.
